(19) United States
(12) Patent Application Publication
(10) Pub. No.: US 2014/0075155 A1
(43) Pub. Date: Mar. 13, 2014

(54) OPERATING METHOD FOR A COMPUTER SYSTEM

(71) Applicant: Horst Lehser, Saarbrucken (DE)

(72) Inventor: Horst Lehser, Saarbrucken (DE)

(73) Assignee: HighTec EDV-Systeme GmbH, Saarbrucken (DE)

(21) Appl. No.: 14/001,581

(22) PCT Filed: Feb. 23, 2012
(86) PCT No.: PCT/DE2012/100045

§ 371 Date: Oct. 17, 2013

(30) Foreign Application Priority Data
Feb. 25, 2011 (DE) 10 2011 012 516.7

(51) Int. Cl. G06F 9/38

(52) U.S. Cl. CPC G06F 9/3885
USPC 712/30

(57) ABSTRACT

A method for operating a computer system, in which a plurality of processes run, within the scope of which a multiplicity of objects are accessed. The method initially predefines, for the subsequent continued operation, which of the processes can be used to access which of the objects. The processes may be distributed among a plurality of processors of a multiprocessor system, and it is initially predefined which of the processors can address which objects.

The invention pertains to a method for operating a computer system in which several processes run.

In computer systems, it is known that programs can allow several different processes to run one after the other in time, interleaved with each other in time, or simultaneously. It is also known that multiprocessor systems using several processors can be used to run processes simultaneously

The programming work required to operate computer systems for running several processes remains within certain limits as long as there are no links between the processes. Without interactions between the processes, there are no data or functions common to the processes. As the degree to which the processes are linked increases, the complexity of the operating programs and thus the probability of errors also increase significantly.

The invention is based on the goal of reducing the amount of work required to operate multiprocessor computer systems and to increase their operational reliability.

This goal is achieved by a method of the type mentioned above, which is characterized in that which of the objects can be accessed by which processes is defined at the beginning for subsequent operation.

In the presence of a plurality of interlinked processes, the inventive definition, which is generally applicable to subsequent operation, offers the advantage of a program structure which is simple, logically clear, and resistant to error.

In an especially advantageous embodiment of the invention, the observance of the initial definition is monitored automatically; this excludes unwanted, incorrect linkages between processes and thus facilitates the subsequent operation of the computer system by a program to an even greater degree.

The processes can be distributed over several processors of a multiprocessor system, wherein it is defined at the beginning which of the processors are allowed to address which objects. It is obvious that, when programming is done in a higher programming language, this assignment is not made directly but rather indirectly by giving the individual processors appropriate symbols, to which only the processor in question and possibly at least one other processor has access; that is, only the previously mentioned processors can “see” the symbols in question.

The previously mentioned objects comprise data stored in memory and/or processor-generated data, which can be “seen” by another processor when there exists a corresponding linking function. If links are present, the previously mentioned objects therefore comprise objects which are addressable by more than one of the processors of the multiprocessor system.

The above-mention observance of the definition can be monitored automatically by a software development tool, which facilitates the programming of the computer system for subsequent operation. When this development tool is used, it is impossible for any links which violate the definition to be produced.

The previously mentioned software development tool is preferably based on the linker program of a program development system designed for the multiprocessor system. Through modification of the linker program, the initial definition can be realized with little effort, wherein the linker program also monitors the observance.

The invention is explained in further detail in the following on the basis of an exemplary embodiment and the attached drawings, which refer to this exemplary embodiment:

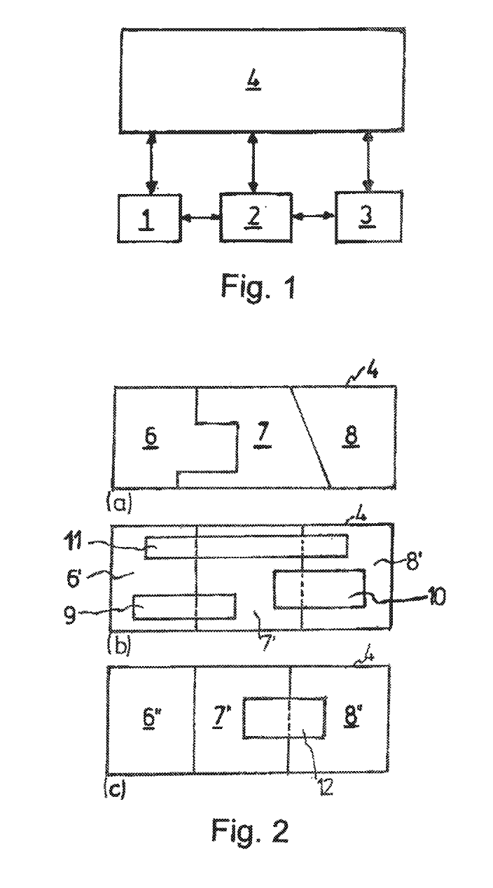

FIG. 1 shows a schematic diagram of a multiprocessor computer system, and

FIG. 2 shows a diagram explaining the assignment of the data to the processors of the multiprocessor system.

In the example shown in FIG. 1, a computer system comprises three processors 1, 2, 3, which can be connected to each other, and an object area 4 comprising data storage and peripherals, some or all of which can be addressed by each of the processors.

The computer system shown in FIG. 1 could be operated in such a way that each of the processors 1, 2, 3 runs a program independently, wherein there is no interaction of any kind between the programs; that is, each of the three processors 1, 2, 3 calls upon only part of the object area 4 as it runs its program, this characteristic meaning, among other things, that it does not connect with any of the other processors. Each of the processors 1, 2, 3 “sees” only a part 6, 7, or 8 of the object area 4, as illustrated in FIG. 2a.

In the contrasting case, the processing of a single program could be distributed over all of the processors 1, 2, 3, so that the area visible to each of the processors comprises the entire object area 4.

At a relatively low degree of distribution of the program processing, largely independent programs which interact to a greater or lesser degree can run on each of the three processors. That is, in addition to subareas 6′, 7′, and 8′ of the object area 4, each of which can be seen by only one of the three processors 1, 2, 3, there exist, according to FIG. 2b, subareas 9, 10, 11, subarea 9 being visible only to processors 1 and 2, subarea 10 only to processors 2 and 3, whereas subarea 11 is accessible to all three processors.

FIG. 2c pertains to an operational case in which a program is running on processor 1 independently, without any interaction, while accessing subarea 6″ of the object area 4, whereas processors 2 and 3 are able to see not only their own exclusive subareas 7″ and 8″ but also a common subarea 12.

According to the invention, it is established in general at the beginning for subsequent operation, for each of the cases described above, which of the processors 1, 2, 3 or which program can access which objects.

1-8. (canceled)

9. A method for operating a computer system in which several processes can run, within the scope of which a plurality of objects is accessed, the method comprising initially defining for subsequent operation which objects can be accessed by which processes.

10. The method according to claim 9, including distributing processes over several processors of a multiprocessor system, and initially defining which processors are allowed to address which objects.

11. The method according to claim 9, wherein the objects comprise data stored in memory and/or data generated by a processor.

12. The method according to claim 10, wherein the objects comprise objects which are addressable by more than one of the processors of the multiprocessor system.

13. The method according to claim 9, wherein the initial definition is suspended only temporarily during the subsequent operation of the computer system.

14. The method according to claim 9, further including monitoring observance of the initial definition.

15. The method according to claim 14, wherein the observance of the initial definition is monitored by a software development tool which facilitates programming of the computer system for subsequent operation.

16. The method according to claim 15, wherein the software development tool is based on the linker program of a program development system designed for the multiprocessor system.
